(19) United States
(12) Patent Application Publication
(10) Pub. No.: US 2006/0269093 A1
(43) Pub. Date: Nov. 30, 2006

(54) Loudspeaker with flexible port

(76) Inventor: Jeffery James Coombs, Lafayette, CA (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 11/431,793

(22) Filed: May 9, 2006

Related U.S. Application Data
(60) Provisional application No. 60/678,925, filed on May 9, 2005.

(51) Int. Cl. H04R 1/02

(52) U.S. Cl. 381/386

(57) ABSTRACT

A subwoofer loudspeaker assembly is mounted in a location separated from a listening area by a barrier, such as a wall or ceiling, and directs sound into the listening area. The loudspeaker assembly includes a loudspeaker device having a sound driver mounted within a housing having an output port. A flexible and elongated sound port includes an input end coupled to the housing output port and an output end coupled to an opening in the barrier between the loudspeaker housing and the listening area. The output end of the elongated sound port is coupled to an adapter mounted into an opening in the barrier. The elongated sound port is acoustically tuned to provide a predetermined desired frequency response.

### RELATED APPLICATION DATA

This application is based on and claims the benefit of U.S. Provisional Patent Application No. 60/678,925 filed on May 9, 2005, the disclosure of which is incorporated herein in its entirety by this reference.

### BACKGROUND

This invention relates generally to loudspeakers. More particularly, it relates to a subwoofer loudspeaker assembly having an elongated, flexible port and adapted for mounting in a location separated from the listening room or listening area.

Many home and commercial audio systems include subwoofer loudspeakers. A subwoofer loudspeaker reproduces the lowest bass frequencies, typically from about 20 Hz to about 200 Hz. It is difficult for small loudspeakers to reproduce frequencies below 40 Hz, especially at higher sound levels. It is advantageous, therefore, to use a subwoofer loudspeaker specifically for reproducing these low frequency sounds.

Subwoofers use drivers with cones typically coming in 10″ or 12″ sizes. Larger diameter drivers tend to be advantageous because low frequencies involve shifting a great deal of air. Subwoofers are usually powered by a high power amplifier, and often an electronic crossover with a low-pass filter is used to ensure that higher frequencies will not be directed to the subwoofer. Traditional subwoofer loudspeaker systems are relatively large and typically are located in the listening area, such as in a comer of a listening room. This presents drawbacks, however, in that the traditional subwoofer loudspeaker system therefore must utilize space in the listening area and often is visually unappealing.

It is an object of the present invention, therefore, to provide a subwoofer loudspeaker system that can reproduce low frequency sounds in the listening area while the subwoofer is located in a separate area from the listening area.

It is another object of the present invention to provide such a subwoofer speaker system that can be located in various separate areas, such as behind a wall of the listening area or above the ceiling of the listening area, and that can be installed in various configurations dictated by those areas.

It is a further object of the present invention to provide such a subwoofer system that can provide high quality audio performance.

It is also an object of the present invention to provide a method for positioning a subwoofer assembly in a location remote from the listening area such that the subwoofer is hidden from the view of a person in the listening area and directs sound from the subwoofer to the listening area.

It is still another object of the invention to provide such a method that readily allows for the positioning of the subwoofer in various types of remote locations and in various configurations.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a loudspeaker assembly for mounting in a location separated from a listening area by a barrier and for directing sound into the listening area. The loudspeaker assembly includes a loudspeaker device having a sound driver mounted within a housing. The housing has an output port for directing sound from the driver out of the housing. A flexible and elongated sound port includes an input end and an output end. The input end of the elongated sound port is adapted to be coupled to the housing output port and the output end of the elongated sound port is adapted to be coupled to an opening in the barrier between the loudspeaker housing and the listening area. The elongated sound port in combination with the loudspeaker device thereby permit the transmission of sound from the loudspeaker device to the listening area through the barrier. The barrier can be a wall or a ceiling separating the loudspeaker assembly from the listening area.

In one advantageous embodiment, the loudspeaker device comprises a subwoofer. The elongated sound port can be acoustically tuned to provide a predetermined desired frequency response. The output end of the elongated sound port is coupled to a flared adapter that is coupled to an opening in the barrier. In one embodiment, the flared adapter is coupled to a fan-shaped wall adapter having a generally rectangular-shaped output. In another embodiment, the flared adapter is coupled to a trim ring mounted into the opening in the barrier.

The invention thereby allows the loudspeaker assembly to be hidden anywhere adjacent to the listening area, such as an attic, basement, cabinetry, adjacent room, or other area external to the listening area.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a perspective view of one embodiment of a subwoofer loudspeaker system according to the present invention, showing the low frequency device and the flexible port.

FIG. 2 is a side elevation view of the subwoofer loudspeaker system of FIG. 1 installed behind a wall of the listening area in one installation configuration.

FIG. 3 is a top plan view of subwoofer loudspeaker system of FIG. 2 installed similar to that of FIG. 2.

FIG. 4A is an exploded perspective view of the flared adapter and fan-shaped wall adapter shown in FIGS. 2 and 3.

FIG. 4B is a perspective view of the assembled flared adapter and fan-shaped wall adapter of FIG. 4A.

FIG. 5 is a side elevation view of the subwoofer loudspeaker system of FIG. 1 installed behind a wall of the listening area in an alternative installation configuration.

FIG. 6 is a side elevation view of the subwoofer loudspeaker system of FIG. 1 installed above a ceiling of the listening area.

FIG. 7 is a top plan view of the installed subwoofer loudspeaker system of FIG. 6.

FIG. 8 shows is a bottom plan view of the installed subwoofer loudspeaker system of FIG. 6.

### DETAILED DESCRIPTION

Reference will now be made in more detail to presently preferred embodiments and methods of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon our invention.

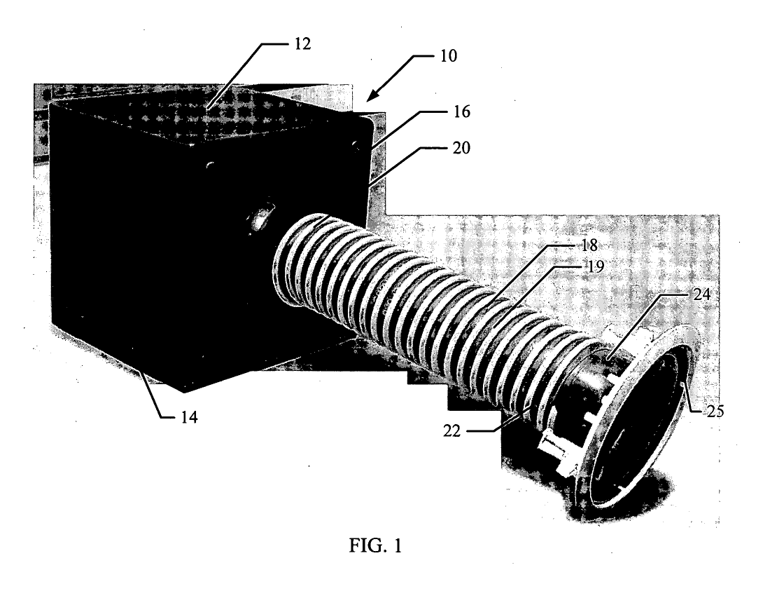

Referring to FIG. 1, a subwoofer assembly 10 in accordance with the present invention is disclosed. The subwoofer assembly 10 includes a low frequency device 12 for generating low frequency sound. The low frequency device 12 includes a driver (not shown) and a housing 14, as are known in the art. Input terminals 15 are mounted on the housing 14 for receiving an audio input signal to the low frequency device. The low frequency signal is provided by dedicated power amplifier (not shown).

The sound generated by the low frequency device 10 is directed from the subwoofer housing 14 through an output port 16 formed in the subwoofer housing 14 and into a flexible, elongated sound port 18. The elongated sound port 18 has a substantially circular cross-section The elongated sound port 18 can be made of any material that is suitably dense, yet flexible, such as rubber or polyurethane material. The elongated sound port 18 includes a spiral rib 19 attached to its exterior, which provides structural support and allows the elongated sound port 18 bend without crimping, thereby maintaining its cross-sectional shape. The elongated sound port 18 has an input end 20 coupled to the housing output port 16 and an output end 22 terminating in a flared adapter 24. The sound port input end 20 is shaped and dimensioned to telescopically receive the subwoofer housing output port 16 and the flared adapter 24 has an input end shaped and dimensioned to telescopically receive the output end 22 of the elongated sound port 18. The flared adapter 24 output end includes a flange 25 for mounting to a wall or other surface.

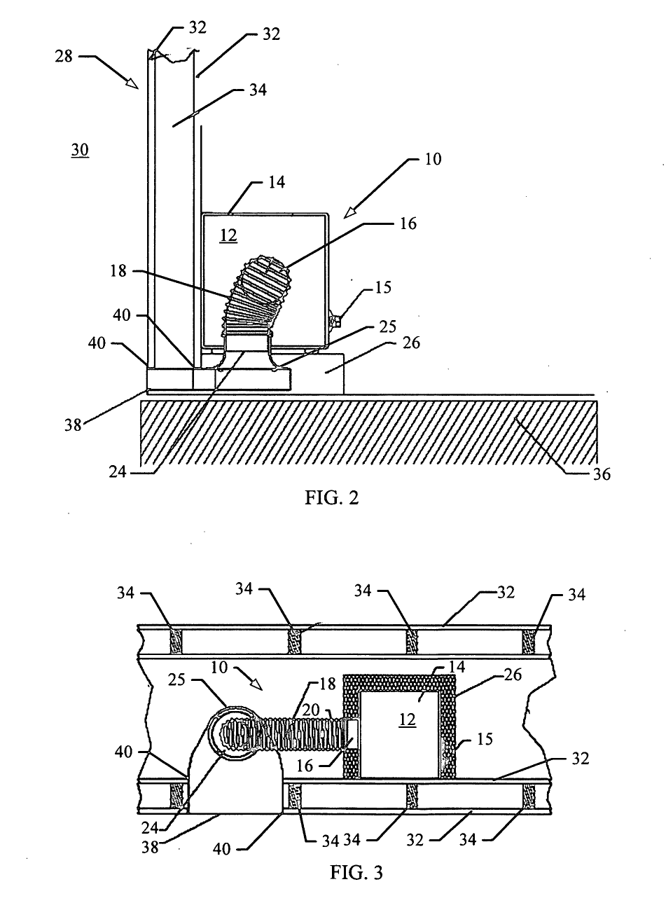

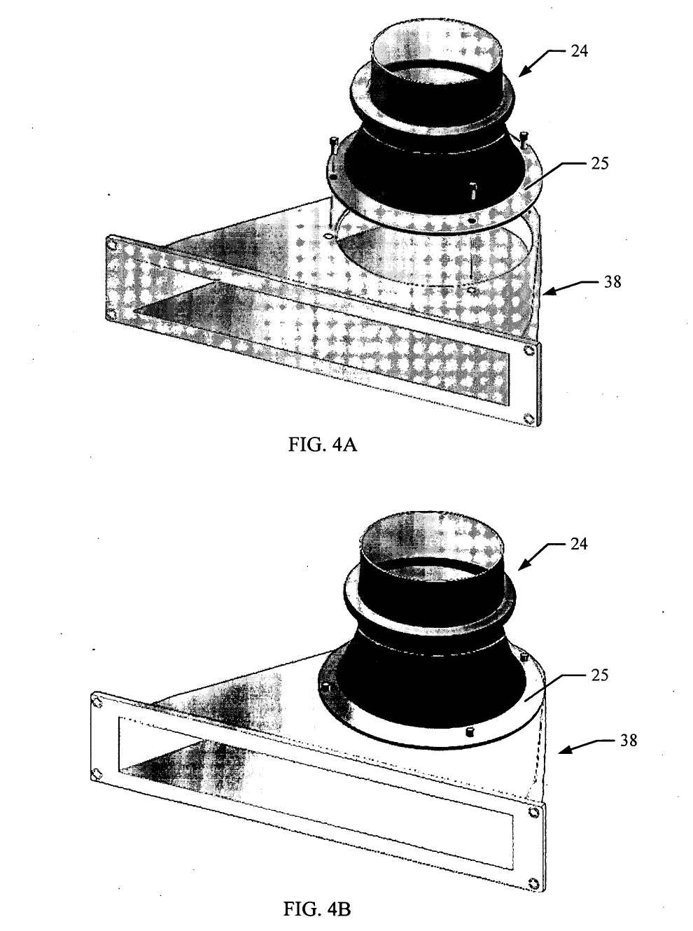

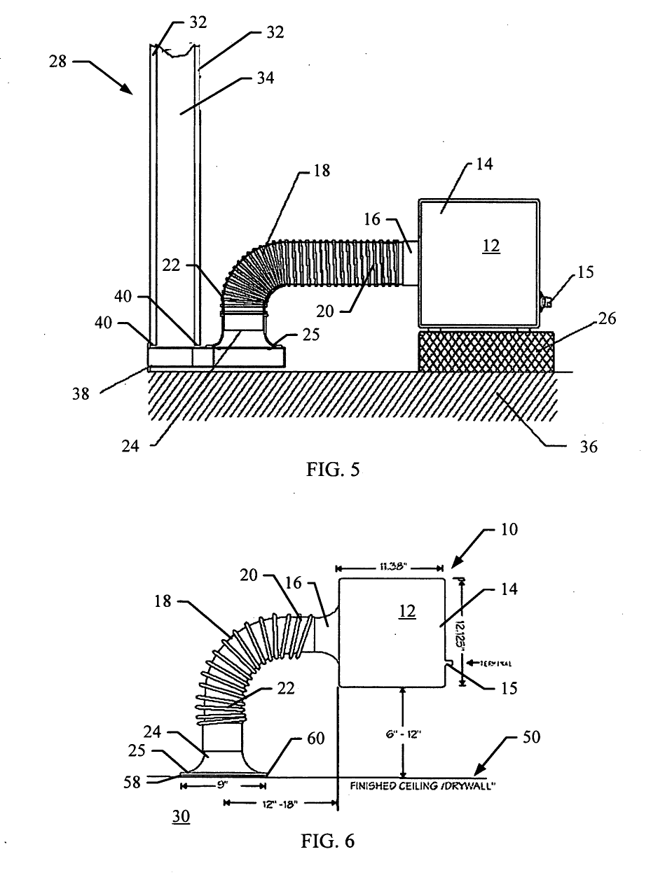

According to one aspect of the present invention, the subwoofer assembly 10 can be installed in a location remote from a listening room or area 30. As shown in FIGS. 2, 3 and 5, for example, the subwoofer assembly 10 is installed behind a wall 28 of the listening room 30. The wall 28 is shown of typical construction including drywall sheets 32 and studs 34. The subwoofer housing 14 is disposed on a pedestal 26 which sits on a floor 36 behind the wall 28. A fan-shaped wall adaptor 38 couples the output end 22 of the elongated sound port 18 to a rectangular opening 40 formed along the base of the wall 28. The flexibility of the elongated sound port 18 allows the subwoofer housing 14 to be positioned in various locations with respect to the wall opening 40. For example, FIG. 2 and FIG. 5 depict two alternative locations of the subwoofer housing 14 with respect to the wall opening 40.

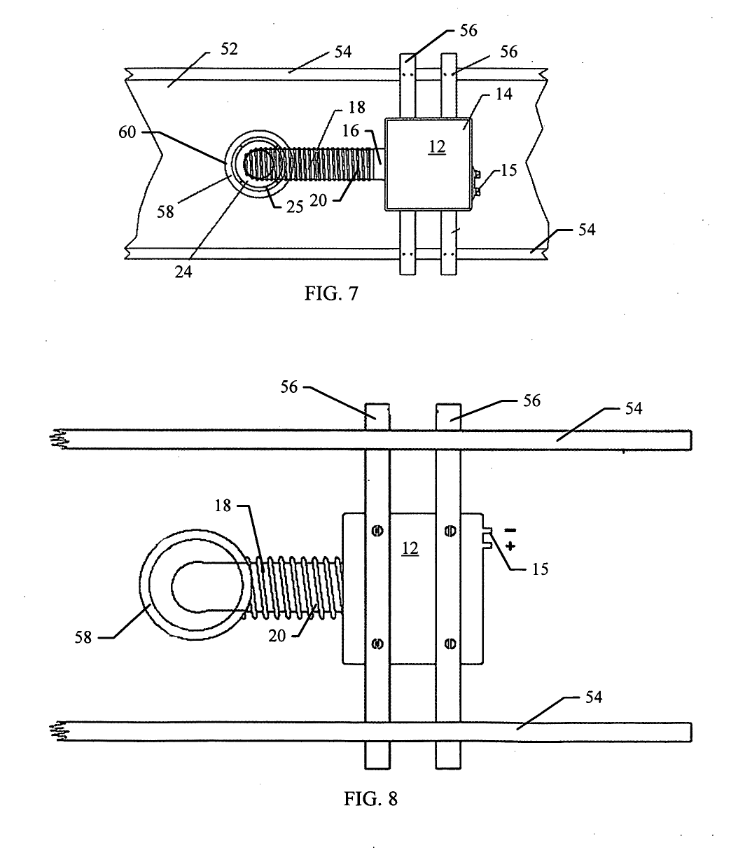

Referring to FIGS. 6-8, the subwoofer assembly 10 is installed above a ceiling 50 of the listening room 30. The ceiling 50 is shown of typical construction including a drywall sheet 52 and rafters 54. The subwoofer housing 14 is mounted to mounting straps 56 extending between the rafters 54. A trim ring 58 couples the output end 22 of the elongated sound port 18 to a circular opening 60 formed in the ceiling 50. The flexibility of the elongated sound port 18 allows the subwoofer housing 14 to be positioned in various locations with respect to the ceiling opening 50.

In one advantageous embodiment, the low frequency device 12 comprises a subwoofer having a conventional 10-inch driver and weighing approximately 35 lbs. to 38 lbs. The housing 14 is made of conventional MDF and measures approximately 12″×12″×11″. The driver input is provided by an external power amplifier. The elongated port 18 comprises a flexible tube having a 4-inch diameter circular cross section and a length in a range of about 17inches to about 23 inches. The elongated port output end 22 terminates a flared adapter 24 having a circular output measuring from about 6¼″ to about 7½″ in diameter. The overall length of the housing output port 14, the elongated port 18 and the flared adapter 24 is about 28″. The flared adapter is attached to a 9-inch diameter trim ring (for an above-ceiling installation) or a fan-shaped adapter (for installation behind a wall or in a cabinet) having a 6¼″ diameter circular input opening and a rectangular output opening measuring approximately 2″×12⅝. The mounting straps 56 used for an above-ceiling installation are rubber straps approximately 30 inches long by 2 inches wide.

From the foregoing disclosure, it will be seen that the present invention has numerous advantages. The apparatus and method of the invention provide improved room aesthetics and excellent aural performance. The subwoofer loudspeaker assembly of the present invention can be positioned in a location that is separate from the listening area. For example, it may be located in the attic space above a listening room or any appropriate space adjacent to the listening room. This hidden placement is facilitated by the elongated, flexible port, which permits placement of the loudspeaker assembly in many different configurations and locations. Moreover, the subwoofer loudspeaker system is easy to install and can be used by custom audio system designers, custom audio system installers, as well as their customers and/or users of such audio systems. Because the flexible port can be acoustically tuned, the apparatus and method of the invention also can provide the aural benefits of a traditional subwoofer loudspeaker.

Having read the disclosure, it will also be understood by those having skill in the art that the modifications may be made to the invention. For example, various locations and configurations of the installed loudspeaker assembly, other than those described, could be used. As another example, other cross-sectional shapes may be employed for the elongated port and the adapters without departing from the spirit of the present invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A loudspeaker assembly for mounting in a location separated from a listening area by a barrier and for directing sound into the listening, the loudspeaker assembly comprising:
a loudspeaker device having a housing and a sound driver mounted within the housing;
an output port for directing sound from the driver out of the housing; and
a flexible and elongated sound port having an input end and an output end, wherein the input end of the elongated sound port is adapted to be coupled to the housing output port and the output end of the elongated sound port is adapted to be coupled to an opening in the barrier between the loudspeaker housing and the listening area;
whereby the elongated sound port in combination with the loudspeaker device permit the transmission of sound from the loudspeaker device to the listening area through the barrier.

2. The loudspeaker assembly of claim 1 wherein the loudspeaker device comprises a subwoofer.

3. The loudspeaker assembly of claim 1 wherein the barrier is a wall.

4. The loudspeaker assembly of claim 1 wherein the barrier is a ceiling.

5. The loudspeaker assembly of claim 1 wherein the elongated sound port is acoustically tuned to provide a predetermined frequency response.

6. The loudspeaker assembly of claim 1 wherein the output end of the elongated sound port is coupled to a fan-shaped adapter mounted into an opening in the barrier and having a generally rectangular-shaped output.

7. The loudspeaker assembly of claim 1 wherein the output end of the elongated sound port is coupled to a trim ring mounted into an opening in the barrier.
